(19) United States
(12) Patent Application Publication
(10) Pub. No.: US 2021/0080201 A1
(43) Pub. Date: Mar. 18, 2021

(54) INTEGRABLE COOLANT CONVEYOR MODULE AND TRANSMISSION HAVING COOLANT CONVEYOR MODULE

(71) Applicant: Schaeffler Technologies AG & Co. KG, Herzogenaurach (DE)

(72) Inventors: Carsten Mayer, Lohr a. Main (DE); Marco Grethel, Bühlertal (DE)

(73) Assignee: Schaeffler Technologies AG & Co. KG, Herzogenaurach (DE)

(21) Appl. No.: 16/620,316

(22) PCT Filed: May 15, 2018
(86) PCT No.: PCT/DE2018/100456

§ 371 Date: Dec. 6, 2019

(30) Foreign Application Priority Data
Jun. 14, 2017 (DE) 10 2017 113 057.8

(51) Int. Cl. F28F 27/02; F16H 57/04

(52) U.S. Cl. CPC F28F 27/02; F28F 2250/08; F16H 57/0412

(57) ABSTRACT

A coolant delivery module for delivering and distributing a coolant includes a housing, a pump, a distribution valve, an electric motor, and an electronic control unit. The housing is equipped with an intake line connection and a plurality of consumer connections. The pump is arranged in the housing and includes a pump inlet connected to the intake line connection, and a pump outlet. The distribution valve is arranged in the housing, connected to the pump outlet, and arranged to selectively connect the pump outlet to the consumer connections. The electric motor is arranged in the housing for driving the pump in a delivery state. The electronic control unit is arranged in the housing, arranged to exert a controlling action on the electric motor, and operatively connected to the distribution valve to control the distribution valve during operation.

### CROSS-REFERENCE TO RELATED APPLICATIONS

This application is the United States National Phase of PCT Appln. No. PCT/DE2018/100456 filed May 15, 2018, which claims priority to German Application No. DE102017113057.8 filed Jun. 14, 2017, the entire disclosures of which are incorporated by reference herein.

### TECHNICAL FIELD

The disclosure relates to a coolant delivery module, i.e. a module provided for delivering coolant and for distributing coolant, which may be provided for use in a clutch, a transmission and/or an automatic transmission of a motor vehicle, having a housing equipped with an intake line connection and a plurality of consumer connections, a pump connected (fluidically) by an inlet to the intake line connection, a distribution valve connected (fluidically) to an outlet of the pump and designed to selectively connect / couple the outlet of the pump (fluidically) to the consumer connections, an electric motor, which drives the pump in a delivery state, and an electronic control unit, which exerts a controlling action on the electric motor. In addition, the disclosure relates to a transmission for a motor vehicle, having this coolant delivery module.

### BACKGROUND

The cooling of various component parts of a drive train of a motor vehicle, such as clutches or transmission stages of a transmission, is known. DE 10 2016 202 656 A1 discloses a clutch device having a valve for controlling a flow of fluid to corresponding friction elements, for example.

Thus, the prior art already discloses ways of implementing an electrified coolant supply. However, the embodiments known from the prior art often have the disadvantage that they are of relatively complex design. The component parts used for the coolant supply, in the form of the pump, the electric motor, the electric control unit thereof, and the distribution valve are often arranged in a distributed manner and are operatively connected to one another in a relatively complex way.

### SUMMARY

According to the disclosure, the pump, the electric motor, the control unit and the distribution valve are arranged / integrated jointly in the housing, and the control unit is operatively connected to the distribution valve in such a way that the control unit controls / exerts a controlling action on the distribution valve during operation.

This results in a compact design of the coolant delivery module. The coolant delivery module can be inserted at the intended location in the drive train in a simple manner with minimal assembly steps.

The electronic control unit may have an interface for a power supply and a CAN bus. For this purpose, a further electronic terminal may be in the housing for corresponding plug connections for implementing the interface. It is thereby possible to implement adequate coupling of the control unit during operation.

The distribution valve may be designed as a (multiway) solenoid valve. For example, the distribution valve may be designed as a conventional switching valve (e.g., in the case of there being two consumer connections) or as a proportional valve/controlled valve (e.g., in the case of three or more than three consumer connections).

In this context, a valve output stage, designed for energizing the distribution valve, may be integrated into the electronic control unit.

There may be one or more bypass orifices and/or a negative overlap on the distribution valve, e.g., on a valve spool of the distribution valve, said orifice/orifices and/or negative overlap serving to make available a basic coolant quantity, irrespective of a valve position of the distribution valve.

There may be sensors, e.g., pressure and/or temperature sensors, in a line system connecting the pump and the distribution valve to one another. In this context, there may be further additional valves, e.g., a pressure limiting valve, as a safety device in the line system. This saves additional installation space.

If the pump and the distribution valve are arranged on a common holding plate, the assembly of the coolant delivery module may be further simplified.

There may be at least two, e.g., at least three, consumer connections, with which the distribution valve interacts for selective connection / coupling to the outlet of the pump. Here, a first consumer connection may be used to introduce a coolant component into a first clutch, a second consumer connection may be used to introduce a coolant component into a second clutch, and a third consumer connection may be used to introduce a coolant into a third clutch or into a gearing stage of a transmission. This further improves the cooling capacity.

If there are a feed connection and a return connection for the connection of a heat exchanger/radiator and these are inserted/integrated into the housing, it is a simple matter to connect a heat exchanger.

In this regard, the feed connection and the return connection may be arranged in/along a line (of the line system) connecting the pump to the distribution valve.

There may be a radiator/heat exchanger bypass valve (in the housing).

If there is a drain connection provided for connection to a reservoir, the fluid medium delivery module can also be attached directly to a reservoir.

The drain connection can be connected to the reservoir with a filter in between. The filter may be integrated into the housing.

If the drain connection is arranged in/along a first line (of the line system) connecting the pump to the distribution valve or in/along a second line connected on the outlet side to the distribution valve, the coolant line is further simplified.

Furthermore, the disclosure relates to a transmission for a motor vehicle, having the coolant delivery module according to the disclosure in accordance with at least one of the embodiments described above. The transmission may be designed as an automatic transmission. The transmission has at least one clutch, e.g., two clutches, and/or a gearing stage/gearwheel stage, which component parts are connected fluidically to a consumer connection of the coolant delivery module.

In other words, according to the disclosure, an automatic transmission is implemented with clutches, e.g., wet clutches, which are supplied with coolant, e.g., cooling oil, by means of an electrically driven pump. In order to make available a compact cooling oil module (coolant delivery module), it is proposed to arrange the electric motor, an electronic control unit for the electric motor and the distribution valve, the pump and the distribution valve in a common housing. In particular, this eliminates a separate valve block in which the valve or valves would have to be mounted separately.

### BRIEF DESCRIPTION OF THE DRAWINGS

The disclosure is now explained in greater detail below with reference to figures, in the context of which various embodiments are illustrated.

In the drawings:

FIG. 1 shows a side view of a coolant delivery module according to the invention in accordance with a first illustrative embodiment, wherein the fundamental arrangement of a pump, of a distribution valve, of an electric motor acting on the pump, and an electronic control unit interacting, in turn, with the electric motor can be seen,

FIG. 2 shows a schematic circuit diagram of the coolant delivery module shown in FIG. 1,

FIG. 3 shows a side view of a coolant delivery module according to the invention in accordance with a second illustrative embodiment, wherein there are additionally connections for a heat exchanger,

FIG. 4 shows a schematic circuit diagram of the coolant delivery module shown in FIG. 3,

FIG. 5 shows a side view of a coolant delivery module according to the invention in accordance with a third illustrative embodiment, wherein there is additionally a drain connection for attachment to a reservoir,

FIG. 6 shows a schematic circuit diagram of the coolant delivery module shown in FIG. 5,

FIG. 7 shows a schematic circuit diagram of a coolant delivery module in accordance with a fourth illustrative embodiment, which differs essentially from the third illustrative embodiment in that the drain connection is integrated directly into a line connecting the pump to the distribution valve and no longer, as in FIG. 6, into a line leading away from the distribution valve on a side remote from the pump,

FIG. 8 shows a side view of a coolant delivery module according to the invention in accordance with a fifth illustrative embodiment, in which a filter coupled to the drain connection is integrated into the housing, and

FIG. 9 shows a schematic circuit diagram of the coolant delivery module shown in FIG. 8.

### DETAILED DESCRIPTION

The figures are of a purely schematic nature and serve only to aid understanding of the disclosure. Identical elements are provided with the same reference signs. Moreover, the different features of the various illustrative embodiments can be combined freely with one another.

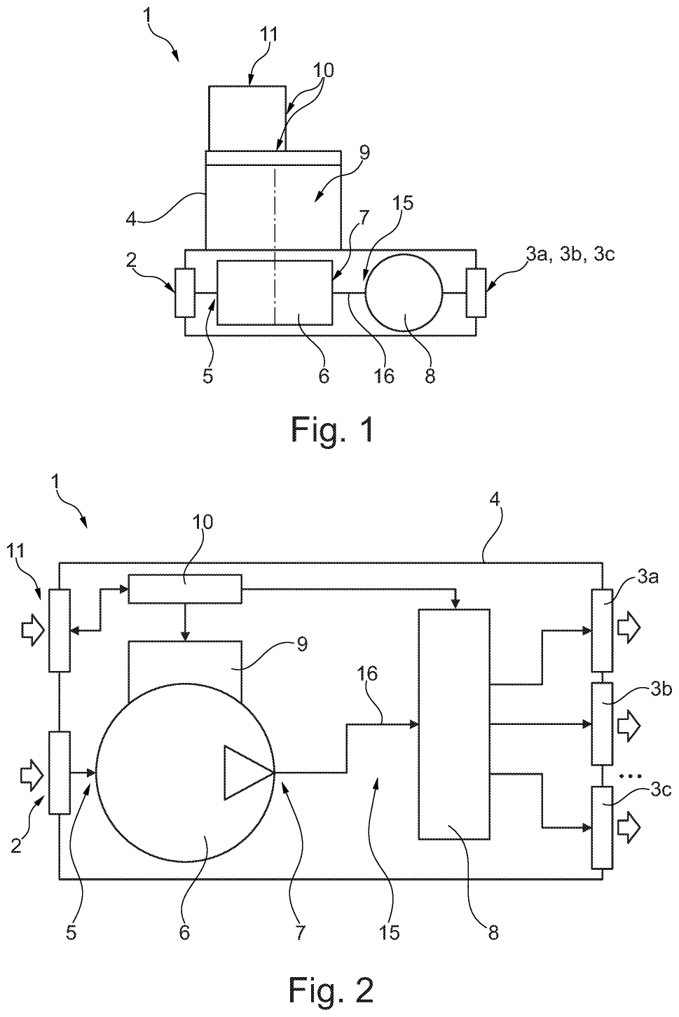

A coolant delivery module 1 in accordance with a first illustrative embodiment is explained in conjunction with FIGS. 1 and 2. During operation in a drive train, the coolant delivery module 1 is used to deliver a coolant, preferably a hydraulic medium, e.g. a cooling oil, and to distribute this coolant to individual consumers. The coolant delivery module 1 is embodied for use in an automatic transmission. The coolant delivery module 1 is designed for mounting in a transmission housing of the automatic transmission. Within the automatic transmission, the coolant delivery module 1 is used to supply one or more clutches and/or one or more gearwheel stages of the automatic transmission with coolant.

As can be seen in principle from FIG. 1, the coolant delivery module 1 has a housing 4. An intake line connection 2 in the form of an inlet is formed in the housing 4. A pump 6 is connected by means of its inlet 5 (referred to below as pump inlet 5) to this intake line connection 2, to which an intake line, e.g. an intake pipe, leading to a tank may be connected during operation. By means of its outlet 7 (referred to below as pump outlet 7), the pump 6 is furthermore connected fluidically, in this case hydraulically, to a distribution valve 8 via a line system 15.

The distribution valve 8 is used for selective connection of the pump outlet 7 to one of several consumer connections 3a to 3c, as also illustrated in FIG. 2. Depending on the valve position of the distribution valve 8, one of three consumer connections 3a, 3b, 3c is thus connected selectively to the pump outlet 7. During operation, a plurality of lines coupled to consumers is connected to the consumer connections 3a, 3b, 3c. In a first valve position, the distribution valve 8 connects the pump outlet 7 to a first consumer connection 3a fluidically, namely hydraulically, as is readily apparent in FIG. 2. In a second valve position of the distribution valve 8, the pump outlet 7 is connected fluidically to a second consumer connection 3b. In a third valve position, the pump outlet 7 is connected fluidically to a third consumer connection 3c. As indicated in FIG. 2 by the three points, any number of consumer connections 3a, 3b, 3c can be provided.

The distribution valve 8 is embodied as a solenoid valve in the form of a switching valve, for which reason the control unit 10 switches the distribution valve 8 backward and forward between the valve positions thereof by means of electric control signals. Alternatively, however, it is also advantageous according to further embodiments to design the distribution valve 8 as a proportional valve / controlled valve, wherein, in particular, the control of the fluid flows to the three consumer connections 3a, 3b, 3c is facilitated.

It can furthermore be seen in FIG. 1 that the pump 6 designed as a delivery pump is coupled in a typical manner to an electric motor 9, which exerts a driving action on the pump 6. To control the electric motor 9, an electronic control unit 10 is operatively connected to the latter. The pump 6, the electric motor 9, the control unit 10 and the distribution valve 8 are arranged jointly in the housing 4. The pump 6 and the distribution valve 8 are mounted on a common holder plate, which, for the sake of clarity, is not illustrated specifically here. The pump 6 and the distribution valve 8 are arranged in a dedicated housing part of the housing 4.

The control unit 10 has an interface 11, which is used as a terminal for a power supply and a CAN bus. The interface 11 has plug connectors, by means of which a power supply and/or CAN bus cable can be connected. Grounding is also accomplished by means of this cable. The control unit 10 furthermore has a circuit board, which is secured in the housing 4. In addition to control commands for controlling the electric motor 9, the control unit 10 also receives control commands for controlling the distribution valve 8 during operation, i.e. for switching the distribution valve 8 between the valve positions thereof.

Details of the other illustrative embodiments are given below, although, for the sake of brevity, only the differences relative to the first or the closest illustrative embodiment are discussed. In principle, the further illustrative embodiments described are constructed and function in accordance with the first illustrative embodiment.

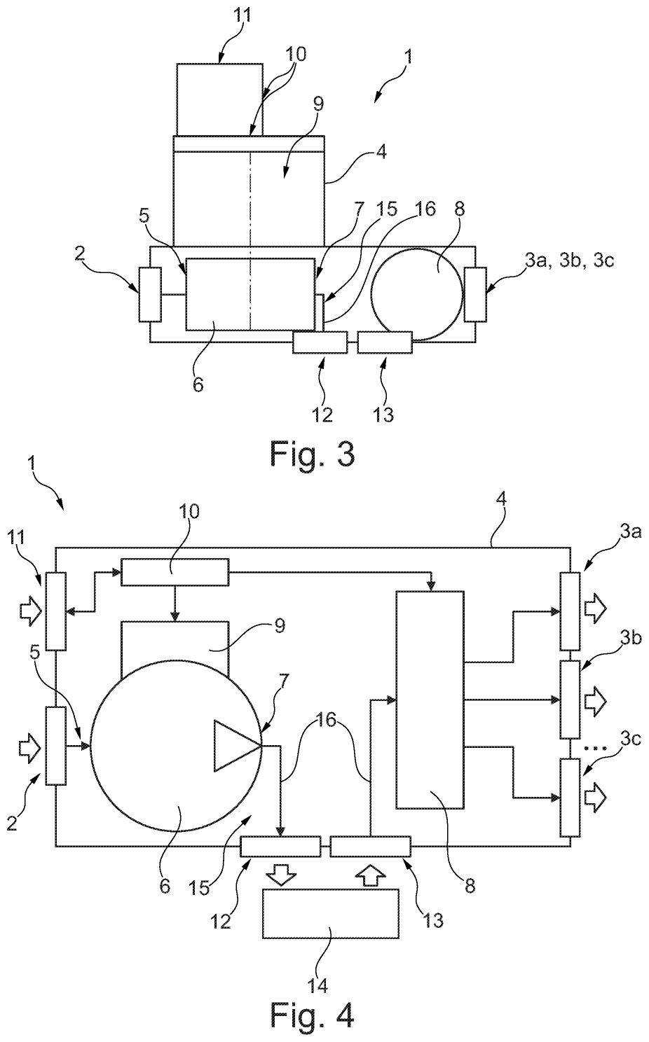

In the second illustrative embodiment in FIGS. 3 and 4, a heat exchanger 14 in the form of a cooling device/radiator can be connected to a first line 16 of the line system 15. The first line 16 is the line which leads from the pump outlet 7 toward the distribution valve 8. The coolant delivery module 1/the line 16 is equipped with a feed connection 12 and a return connection 13. The feed connection 12 and the return connection 13 are incorporated into the housing 4. The feed connection 12 is connected directly to the pump outlet 7, while the return connection 13 is connected directly to the distribution valve 8 on the inlet side. In the state in which it is not connected by the two connections 12 and 13, the first line 16 is interrupted within the housing 4. During operation, however, a continuous line between the pump 6 and the distribution valve 8 is once again formed by the connection of the heat exchanger 14 to the connections 12 and 13.

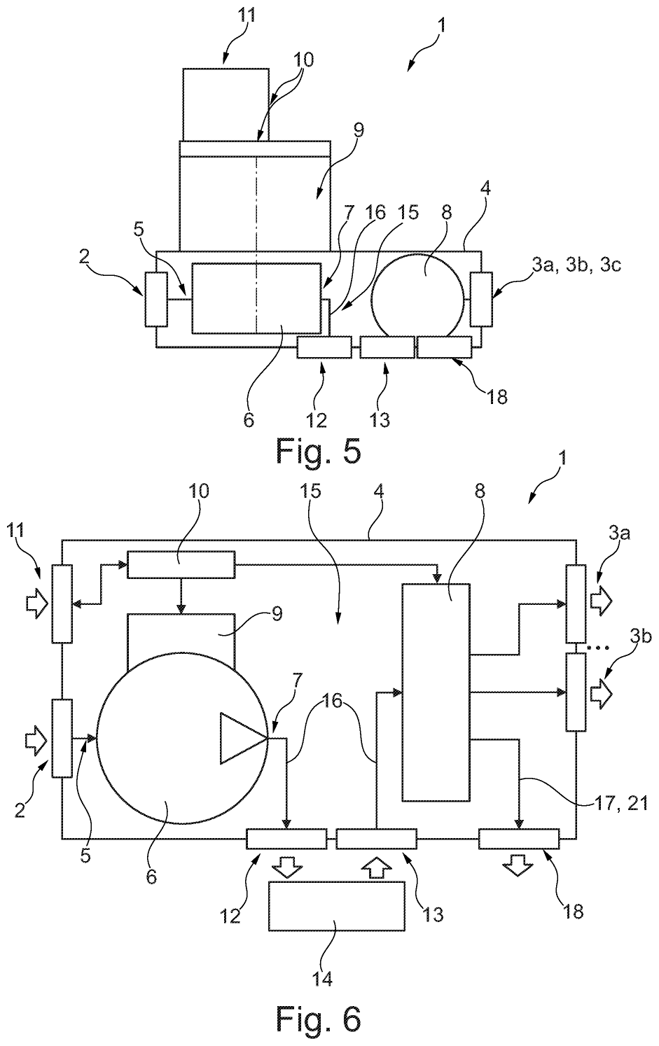

The third illustrative embodiment in FIGS. 5 and 6 differs, in turn, from the second illustrative embodiment in FIGS. 3 and 4 in that a drain connection 18 is additionally provided in the housing 4. The drain connection 18 is arranged in parallel with the other consumer connections 3a, 3b, 3c. The drain connection 18 is connected to the distribution valve 8 on the outlet side via a second line 17 designed as a drain line 21. Via the second line 17, the drain connection 18 is thus provided as a further connection to the distribution valve 8. During operation, a return tank/reservoir 19 (ref. FIG. 8) is connected fluidically/hydraulically to this drain connection 18 (preferably with an external filter in between).

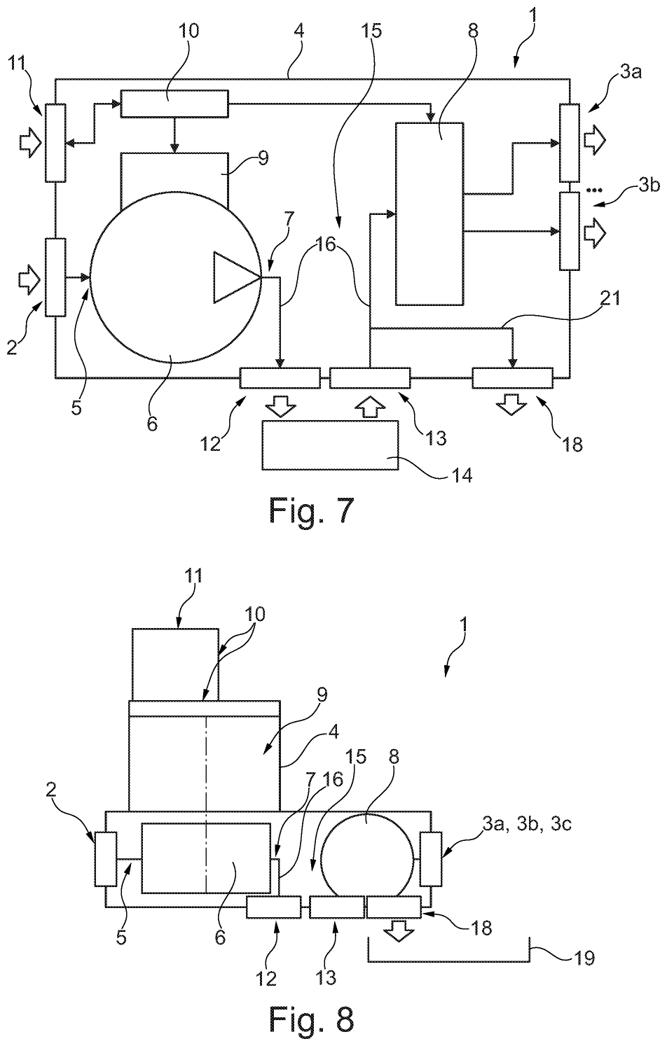

In conjunction with the fourth illustrative embodiment shown in FIG. 7, it is in principle apparent that the drain connection 18 can also be connected on the inlet side of the distribution valve 18, as compared with the third illustrative embodiment. In this fourth illustrative embodiment, the drain connection 18 is connected via the drain line 21 to the first line 16, which connects the pump outlet 7 to the distribution valve 8 during operation.

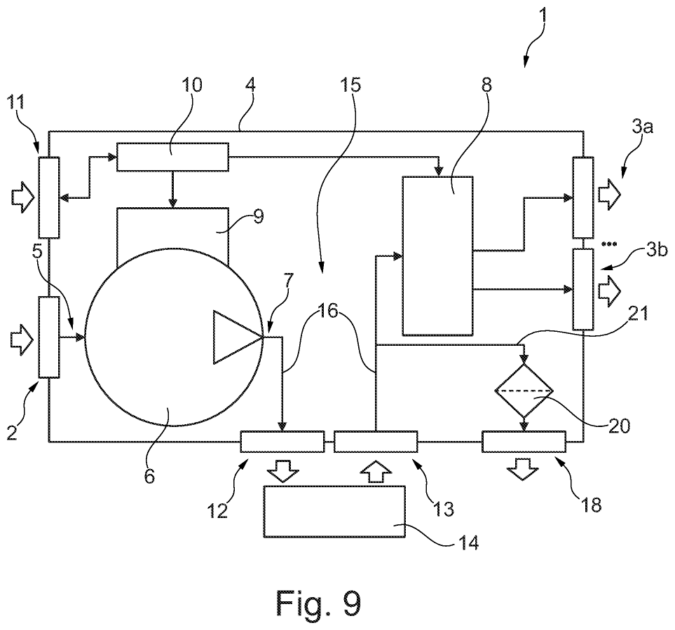

According to the fifth illustrative embodiment in FIGS. 8 and 9, it is also possible, as compared with the fourth illustrative embodiment, to provide a filter 20 directly in the housing 4. The filter 20 is arranged in the drain line 21, between the drain connection 18 and the first line 16. In this connection, it should also be noted that the reservoir 19 can be used as an intermediate reservoir, from which a transmission and/or clutch actuator system of the automatic transmission can furthermore be supplied during operation.

In other words, according to the disclosure, a connection of the electric motor (electric motor 9), an electronic control unit (control unit 10) for controlling the electric motor 9 and the distribution valve 8, the pump 6 and the distribution valve 8 is implemented in a common housing assembly (common housing 4). In one variant, interfaces (feed and return connections 12, 13) with an external heat exchanger 14 are provided. In another variant, an interface (drain connection 18) with a reservoir 19 is provided (optionally via an oil filter/filter 20).

The module 1 according to the disclosure is distinguished by a compact and easy to assemble structure. The module 1 forms a ready assembled module 1, to which the customer then merely connects a minimum of hydraulic connection applications, e.g. piping and an electric plug.

Interfaces of this module 1 are an intake pipe connection (intake line connection 2), a plurality of cooling oil connections (consumer connections 3a, 3b, 3c) for the individual consumers and an electric interface 11, which includes the power supply and a CAN bus. In the additional variants, connections 12, 13, 18 to and from the oil cooler (heat exchanger 14) and to the filter 20 or reservoir 19 are added. The input for the pump 6 in the form of a voltage input, speed input or volume flow input as well as the required oil distribution between the consumers is supplied via the CAN bus by a higher-level control unit. The pump 6 of the module 1 is driven by an integrated electric motor 9, which, in turn, is controlled by the integrated control unit 10. The module 1 contains at least one distribution valve 8 for distributing the cooling oil volume flow supplied between a plurality of cooling oil consumers (e.g. clutches or gearsets). The valve magnet (valve spool of the distribution valve 8) is controlled by the control unit 10 of the electric motor 9 of the pump. For this purpose, a valve output stage is integrated into the control unit 10. A basic cooling oil quantity for the consumers can be achieved independently of the valve position by means of bypass orifices or negative overlaps on the valve spool. The integration of one or more sensors, e.g. pressure or temperature sensors, or further active or passive valves (a pressure limiting valve DBV as a safety device for instance) in this compact valve block is furthermore conceivable (FIGS. 1 and 2).

One variant of the cooling module 1 has the connections 12, 13 to and from the heat exchanger 14 as additional interfaces. Considered in the hydraulic flow, these connections 12, 13 are situated between the high-pressure side (pump outlet 7) of the pump 6 and the distribution valve 8. For low temperatures and associated high oil viscosity, the integration of a radiator bypass valve in the module 1 is possible (FIGS. 3 and 4).

Another variant has an interface with an oil filter 20, by means of which the filtered oil is discharged directly into the oil sump, in parallel with the connections 12, 13 for the cooling oil consumers and possibly also in parallel with the distribution valve 8. In this way, an increase in the flow rate through the radiator 14 can also be achieved without necessarily delivering a greater volume flow through the clutch / dual clutch / triple clutch (FIGS. 5, 6, 7).

In another variant, although not a compulsory feature, some of the oil is discharged through an integrated filter 20 into an intermediate reservoir 19, from which the transmission and clutch actuator system is then supplied (FIGS. 8 and 9).

### REFERENCE NUMERALS

1 coolant delivery module

2 intake line connection

3a first consumer connection

3b second consumer connection

3c third consumer connection

4 housing

5 inlet of the pump

6 pump

7 outlet of the pump

8 distribution valve

9 electric motor

10 control unit

11 interface

12 feed connection

13 return connection

14 heat exchanger

15 line system

16 first line

17 second line

18 drain connection

19 reservoir

20 filter

21 drain line

1.-10. (canceled)

11. A coolant delivery module for delivering and distributing a coolant, comprising:
a housing equipped with an intake line connection and a plurality of consumer connections;
a pump arranged in the housing and comprising:
a pump inlet connected to the intake line connection; and
a pump outlet;
a distribution valve:
arranged in the housing;
connected to the pump outlet; and
arranged to selectively connect the pump outlet to the consumer connections;
an electric motor arranged in the housing for driving the pump in a delivery state; and
an electronic control unit:
arranged in the housing;
arranged to exert a controlling action on the electric motor; and
operatively connected to the distribution valve to control the distribution valve during operation.

12. The coolant delivery module of claim 11, wherein the electronic control unit comprises an interface for a power supply and a CAN bus.

13. The coolant delivery module of claim 11, wherein the distribution valve is a solenoid valve.

14. The coolant delivery module of claim 11, further comprising a common holding plate, wherein the pump and the distribution valve are arranged on the common holding plate.

15. The coolant delivery module of claim 11, wherein the distribution valve interacts with at least two consumer connections for selective connection to the pump outlet.

16. The coolant delivery module of claim 11, further comprising a feed connection and a return connection for connecting of a heat exchanger.

17. The coolant delivery module of claim 16, wherein the feed connection and the return connection are arranged in a line connecting the pump to the distribution valve.

18. The coolant delivery module of claim 11, further comprising a drain connection for connection to a reservoir.

19. The coolant delivery module of claim 18, wherein the drain connection is arranged in a first line connecting the pump to the distribution valve, or in a second line connected an outlet side to the distribution valve.

20. A transmission for a motor vehicle comprising the coolant delivery module of claim 11.
